(19) United States
(12) Patent Application Publication
(10) Pub. No.: US 2014/0041745 A1
(43) Pub. Date: Feb. 13, 2014

(54) Water Supply Fixture For Electronic Bidet Toilet Seat

(71) Applicant: Vinh T. Vu, Irvine, CA (US)

(72) Inventor: Vinh T. Vu, Irvine, CA (US)

(21) Appl. No.: 13/571,353

(22) Filed: Aug. 10, 2012

(51) Int. Cl. F16L 11/00; F16L 43/00

(52) U.S. Cl. 138/109; 285/179

(57) ABSTRACT

A water supply fixture is used to connect water supply source to an electronic bidet toilet seat. The water supply fixture includes two main portions. The first portion is a decorative rigid assembly that can be designed to blend in with the electronic bidet toilet seat appearance. This first portion, when being installed with the electronic bidet toilet seat, will occupy the plain sight of the user's view when he or she is in the standing position and looking down to the bidet toilet seat. The second portion of the water supply fixture is a flexible supply hose which generally may not be aesthetically good-looking,. This unaesthetic flexible supply hose, when being used, will be partly covered by the first portion of the water supply fixture, largely hidden underneath the electronic bidet toilet seat, and almost completely out of the user's view when looking down to the bidet toilet seat.

### BACKGROUND OF THE INVENTION

This invention relates generally to a water supply fixture that is used to connect a water supply source to an electronic bidet toilet seat.

Conventional electronic bidet toilet seat includes a flexible supply hose that is used to connect a water source to the electronic bidet toilet seat. For practical or cost reason, the flexible supply hose is simply a common, off-the-shelf, flexible hose that is, when used, unaesthetically sticking out on the side of the electronic bidet toilet seat. The unaesthetic flexible supply hose, not only ruins the look of a generally modern looking of the electronic toilet bidet seat, its bulky and unattractive look also makes the electronic bidet seat itself looks like an afterthought that does not blend well in any formal bathroom decor.

Accordingly, it is desirable to develop a water supply fixture that can hide most of the unaesthetic flexible water supply hose. The water supply fixture itself, instead being an eyesore but a necessary component to connect water supply source to the electronic bidet toilet seat, it can become a decor component that can be designed to various shapes and forms to improve the overall appearance of the electronic bidet toilet seat.

### SUMMARY OF THE INVENTION

An example water supply fixture consists of two main portions. The first portion is a decorative rigid metal machined or plastic molded assembly that can be designed to blend in with the electronic bidet toilet seat appearance. This first portion of the fixture, when being installed with the electronic bidet toilet seat, will occupy the plain sight of the user's view when he or she is in the standing position and looking down to the toilet seat. This first portion of the water supply fixture, not only acts as an aesthetic cover, it also conduits water to the electronic bidet toilet seat.

The second portion of the water supply fixture is a flexible supply hose which generally may not be aesthetically good-looking. However, this unaesthetic flexible supply hose, when being, used, will be partly covered by the first portion of the fixture and, most importantly, largely hidden underneath the toilet seat. Consequently, the unaesthetic second portion of the water supply fixture will be almost completely out of the user's view if he or she is in the standing position and looking down to the bidet toilet seat.

These and other features of the present invention can be best understood from the following specification and drawings, the following of which is a brief description.

### BRIEF DESCRIPTION OF THE DRAWINGS

FIG. 1 is an assembled view of an example water supply fixture according to this invention.

FIG. 2 is an exploded view of an example water supply fixture according to this invention.

FIG. 3 is a cross-sectional view of an example water supply fixture according to this invention.

FIG. 4 is a perspective view of the water supply fixture when it is being installed with a typical electronic bidet toilet seat.

FIG. 5 is an exploded view of another example (2^{nd} example) water supply fixture according to this invention.

FIG. 6 is a cross-sectional view of the 2^{nd} example water supply fixture.

FIG. 7 is an exploded view of another example (3^{rd} example) water supply fixture according to this invention.

FIG. 8 is a cross-sectional view of the 3^{rd} example water supply fixture.

FIG. 9 is an exploded view of another example (4^{th} example) water supply fixture according to this invention.

FIG. 10 is a cross-sectional view of the 4^{th} example water supply fixture.

FIG. 11 is an exploded view of another example (5^{th} example) water supply fixture according to this invention.

FIG. 12 is a cross-sectional view of the 5^{th} example water supply fixture.

FIG. 13 is an exploded view of another example (6^{th} example) water supply fixture according to this invention.

FIG. 14 is a cross-sectional view of the 6^{th} example water supply fixture.

FIG. 15 is an exploded view of an alternate design according to this invention.

FIG. 16 is a cross-sectional view of an alternate design.

### DETAILED DESCRIPTION OF THE PREFERRED EMBODIMENT

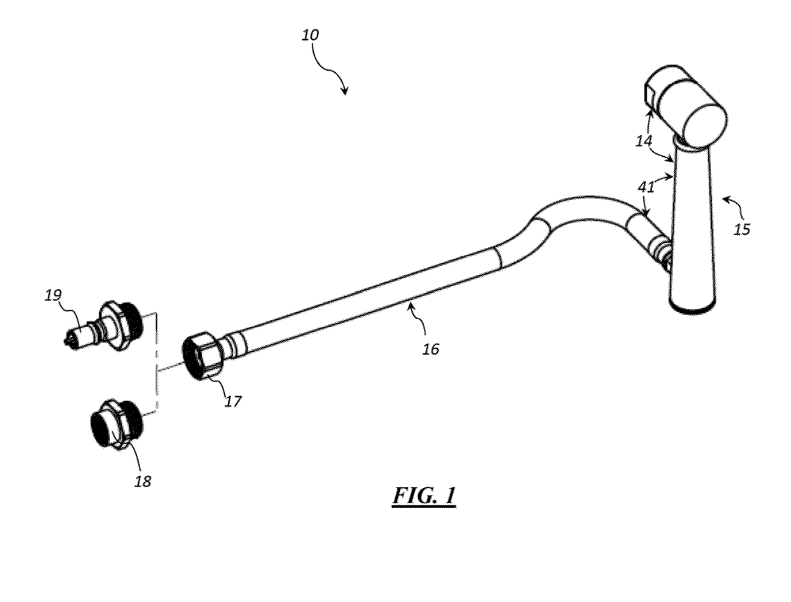

Referring to FIG. 1, a water supply fixture 10 includes two main portions. The first portion of the water supply fixture 10 is the decorative rigid assembly 15 which is clearly visible to the user, when being installed with an electronic bidet seat. The second portion of the water supply fixture 10 is a flexible supply hose 16. This flexible supply hose 16, when installed with the electronic bidet toilet seat, is mostly hidden underneath the electronic bidet toilet seat.

The rigid assembly 15 is intentional designed to not necessarily be an integral part of the flexible supply hose 16. This design intent gives a worker of ordinary skill in this art, the flexibility to design it in various forms or shapes and not have to depend on the ordinary form of the flexible supply hose 16. Furthermore, by not tying up with the flexible supply hose 16, the rigid assembly 15 can be plated in different color and not have to depend on the genetic default color of the flexible supply hose 16.

The water supply fixture 10, as shown, has two key elbows, 14 and 41. These two key elbows 14 and 41 help to direct and hide the flexible supply hose 16 underneath the bidet toilet seat. The bulky and unaesthetic appearance of the flexible supply hose 16, if not properly hidden, will otherwise ruin the seriousness and modern look of the electronic bidet toilet seat.

Elbow 41 works best to hide the flexible supply hose 16 when it is in the orientation as shown in FIG. 1. However, a worker skilled in the art can rotate elbow 41 clockwise or counter clockwise and still achieve a similar result to hide the unattractive flexible supply hose 16.

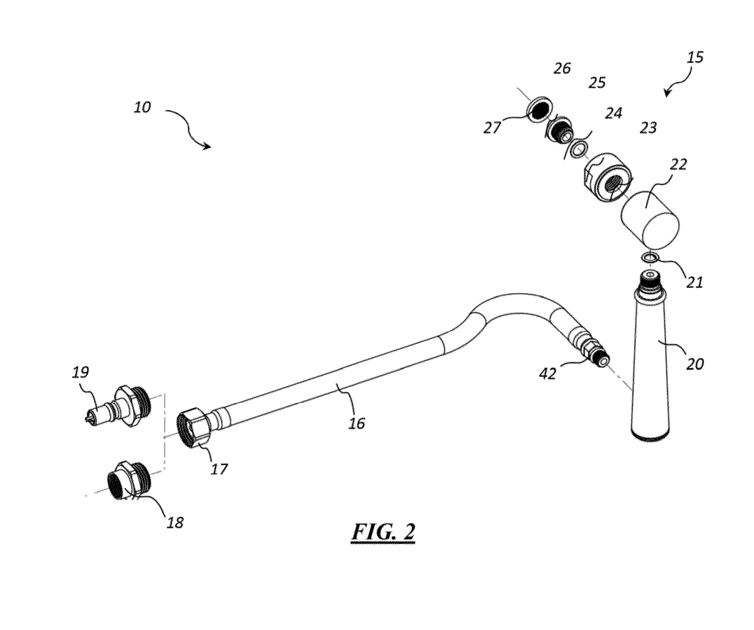

Referring to FIG. 2, the rigid assembly 15 includes pillar 20, and elbow body 22, and adapter 25, and swivel nut 23. The pillar 20 is threaded to the elbow body 22 with a rubber o-ring 21 between them to seal off any water leak.

One end of the flexible supply hose 16 is connected to the rigid assembly 15 via pillar 20. The other end of the flexible supply hose 16 is connected to a water supply fitting that is normally supplied by the electronic bidet toilet seat manufacturers. Because the water supply fittings are generally different from different bidet toilet seat manufacturers, a connector end 17 of the flexible supply hose 16 can be designed in different configurations to fit different water supply fittings. However, as shown, the connector end 17 can be standardized and designed to fit with the most common water supply fittings such as ones that can fit ½ NPSM thread. To allow the standardized connector end 17 to connect with other uncommon water supply fittings, optional fitting adapter such as example fitting adapters 18 and 19 are used to make the connection possible. These optional fitting adapters such as 18 and 19 will make the water supply fixture 10 becoming more universal because it can work with various electronic bidet toilet seat brands that may have unique water supply fittings.

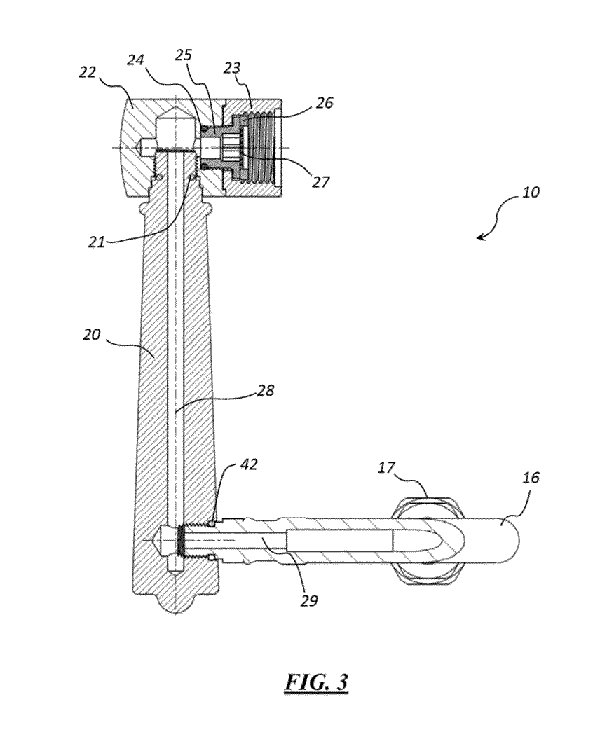

Referring to FIG. 3, the pillar 20 is free to rotate around its lengthwise axis 28. The adapter 25 is used to hold elbow body 22 and the swivel nut 23 together. The rubber o-ring 24 is used to seal off any water leak between the adapter 25 and elbow body 22. The swivel nut 23 is used to connect the whole water supply fixture 10 to an electrical bidet toilet seat water inlet. A rubber gasket 26 is used to seal off any water leak between the swivel nut 23 and the electrical toilet seat water inlet. The rubber gasket 26 has an optional filter screen 27 to prevent contaminant debris in the water from clogging up the electrical bidet toilet seat internal waterway.

At the other end, the pillar 20 connects to the flexible supply hose 16. O-ring 42 on the flexible supply hose 16 is used to seal off any water leak between pillar 20 and flexible supply hose 16.

When use water supply fixture 10 to connect a water supply source to an electronic bidet toilet seat, water passes through the water supply fixture 10 in the following sequences. First, water passes through the optional fitting adapter 18 or 19, the connector end 17 and waterway 29 of the flexible supply hose 16. Next, water passes though pillar 20, then elbow body 22, adapter 25, gasket 26, swivel nut 23, and finally to the bidet toilet seat water inlet.

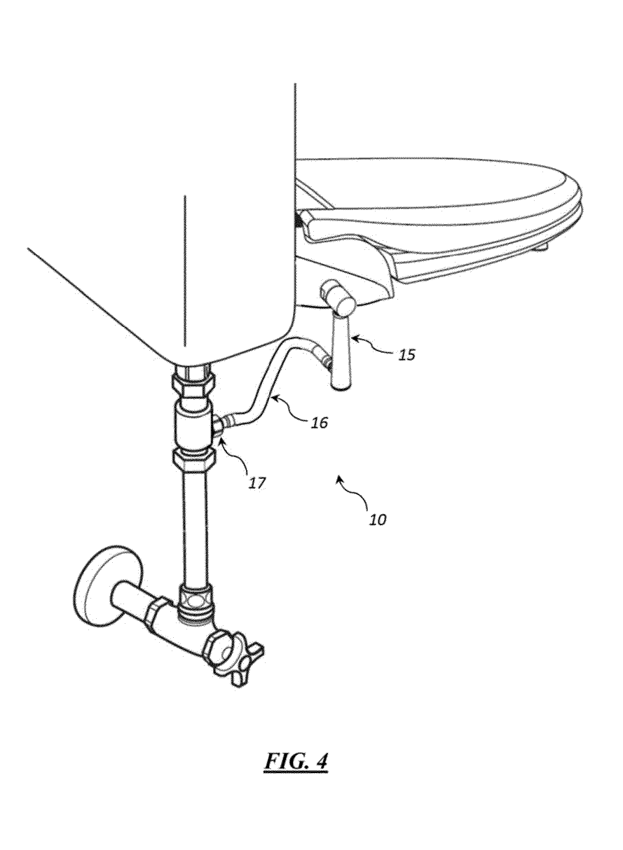

Referring to FIG. 4, water supply fixture 10 is shown when it is being used. One of its ends is connected to an electronic bidet toilet seat water inlet. The other end is connected to a water supply fitting.

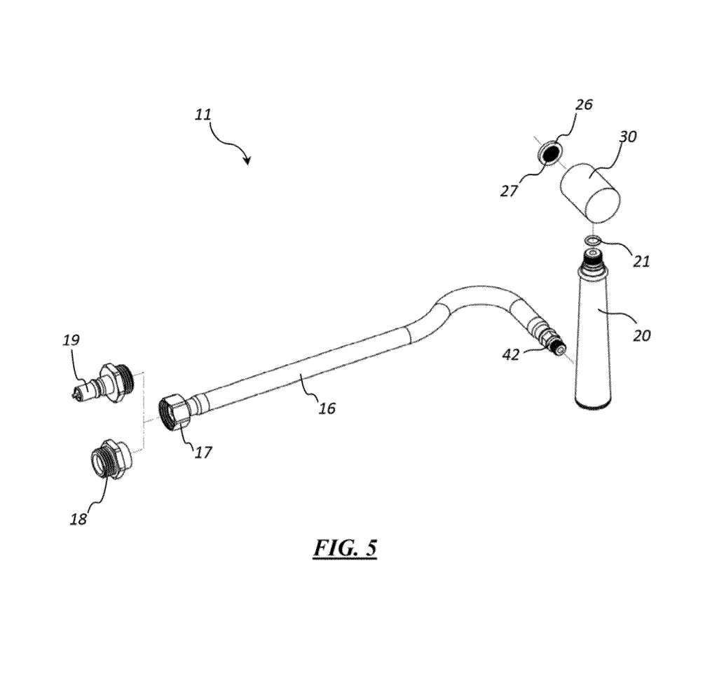

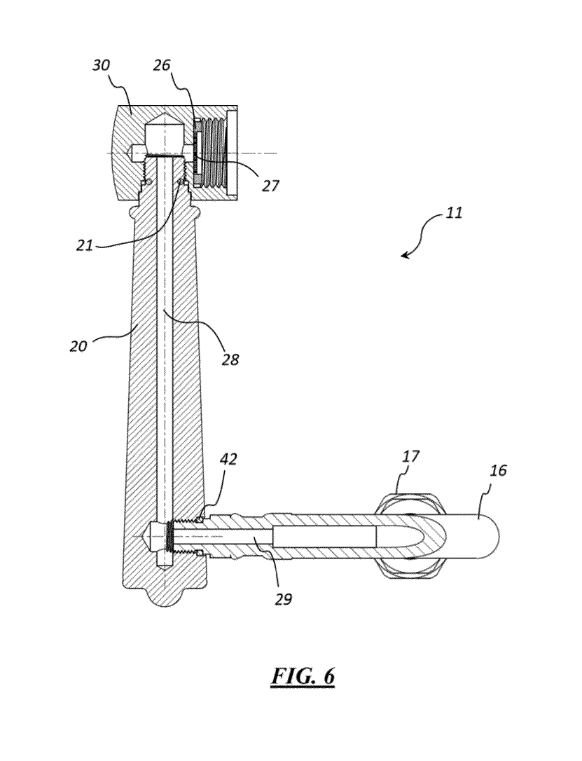

Referring to FIG. 5, another water supply fixture (2^{nd} example) 11, according to this invention, is almost identical to the water supply fixture 10, except that the adapter 25, o-ring 24, and swivel nut 23 are removed. A longer elbow body 30, when being used, is screwed directly to the electronic bidet toilet seat water inlet. FIG. 6 shows cross-sectional view of water supply fixture 11.

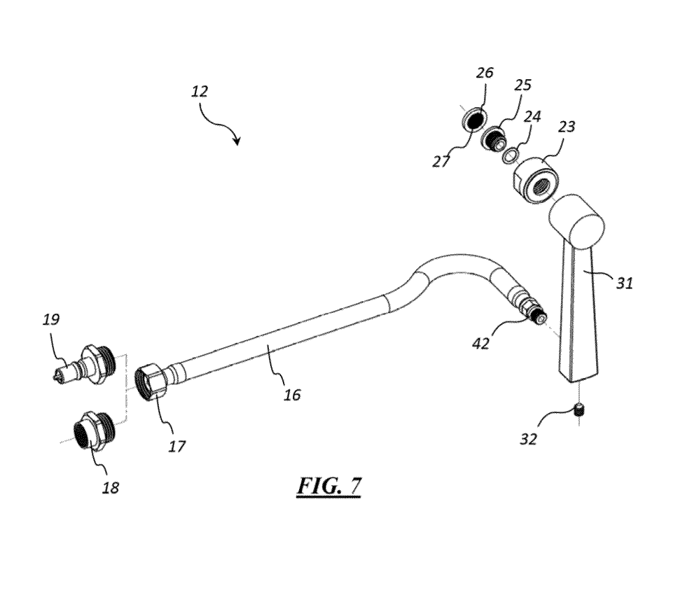

Referring to FIG. 7, another water supply fixture (3^{rd} example) 12, according to this invention, includes a forging or casting/molding) body 31. Compared with water supply fixture 10, the forging body 31 is used to replace pillar 20 and elbow body 22. The forging body 31 can be of any configuration known to a worker skilled in the art.

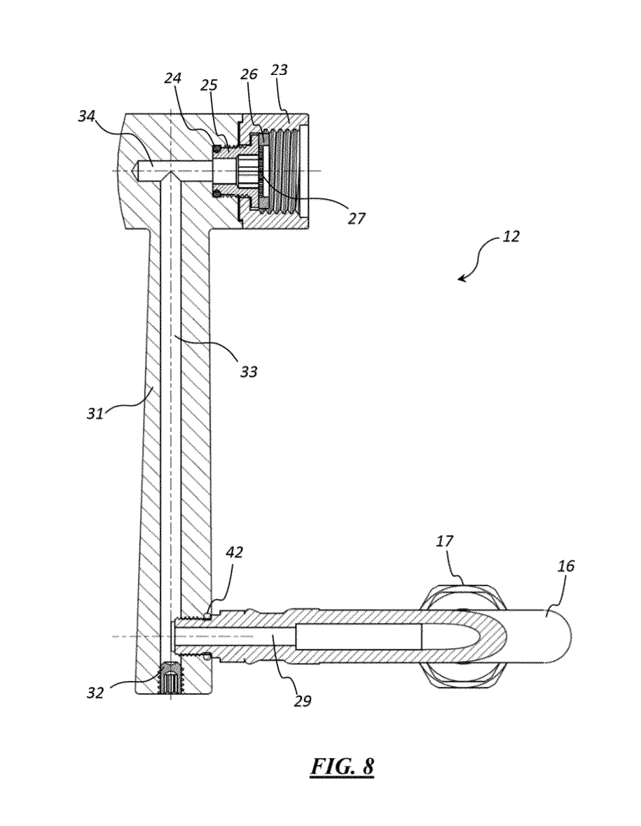

Referring to FIG. 8, the forging body 31 includes water conduits 33 and 34. A screw 32 is used to cap off an opening end of the water conduit 33.

When use water supply fixture 12 to connect the water source to the bidet toilet seat, the water first passes through the optional fitting adapter 18 or 19, the connector end 17 and water conduit 29 of the flexible supply hose 16, then, through the water conduits 33 and 34 of the forging body 31, adapter 25, and gasket 26, swivel, nut 23, and finally to the electronic bidet toilet seat water inlet.

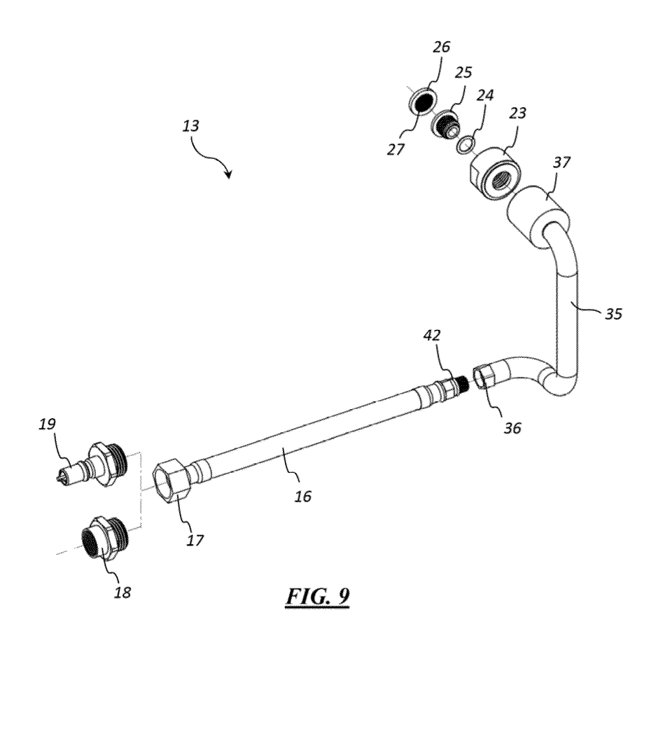

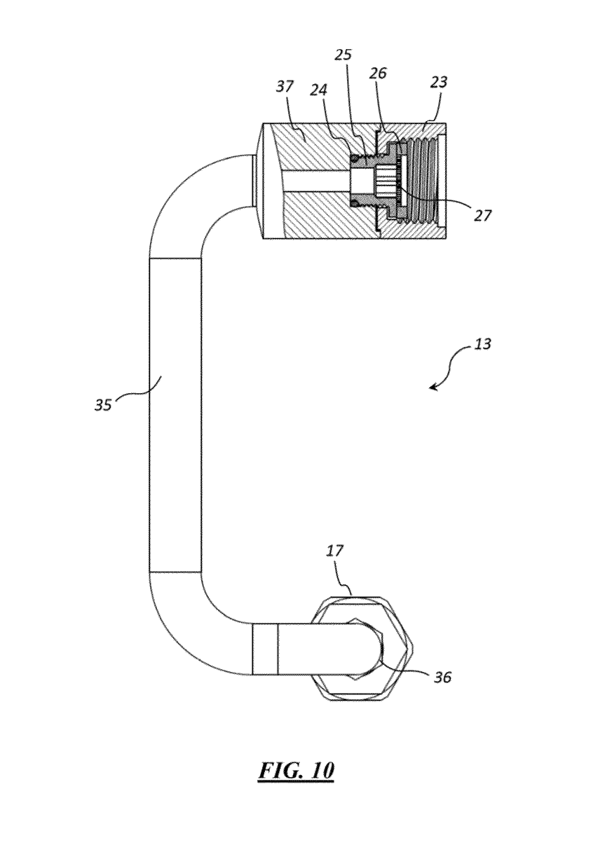

Referring to FIG. 9, another water supply fixture 13 (4^{th} example), according to this invention, includes a bended tubular tube 35 and adapters 36 and 37. The bended tubular tube 35 is either threaded or brazed to adapters 36 and 37. When being used, this water supply fixture 13 works exactly as described for the water supply fixture 10. FIG. 10 shows cross-sectional view of water supply fixture 13.

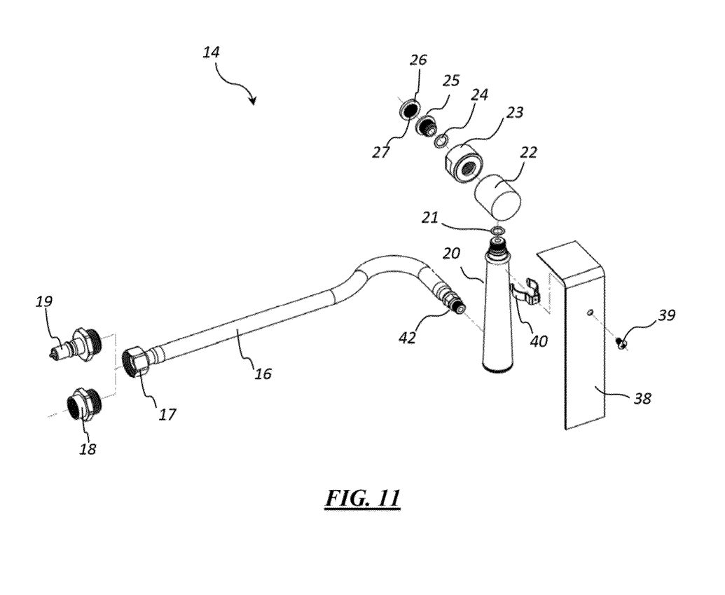

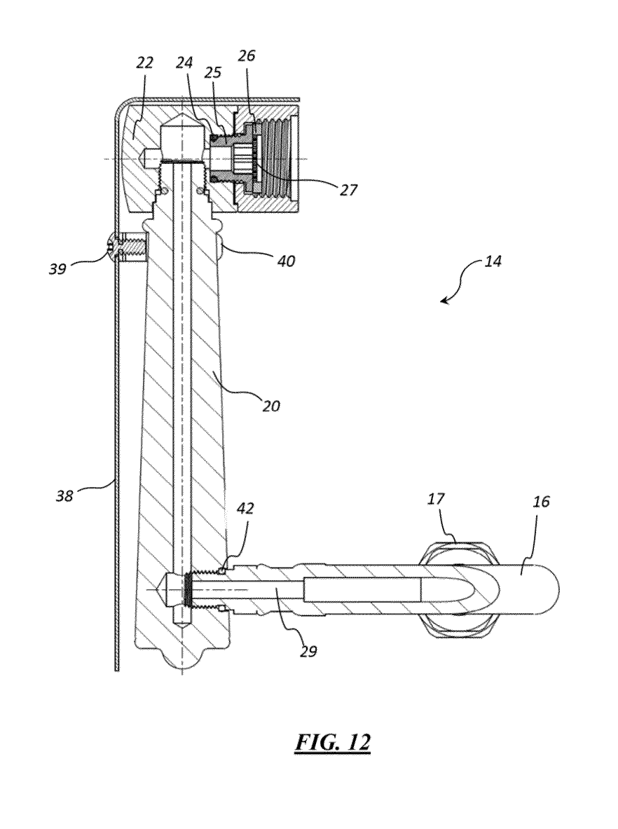

Referring to FIG, 11, another water supply fixture 14 (5^{th} example), According to this invention, wherein the example water supply fixture 10 is now accompanied with a cover 38. This cover 38 is used to cover an electrical cord that is needed to provide electrical power to the electronic bidet toilet seat. The cover 38 can be designed as an integral part of the water supply fixture 10 or it can be a separate piece, as shown in FIG. 11. The cover 38 can be clamped to the water supply fixture 10 by using a screw 39 and a clamp 40. FIG. 12 shows cross-sectional view of water supply fixture 14.

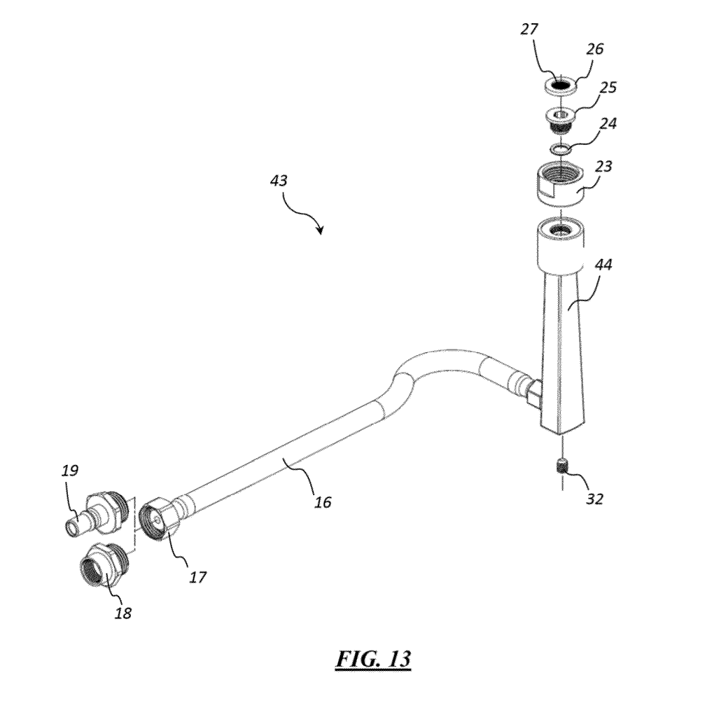

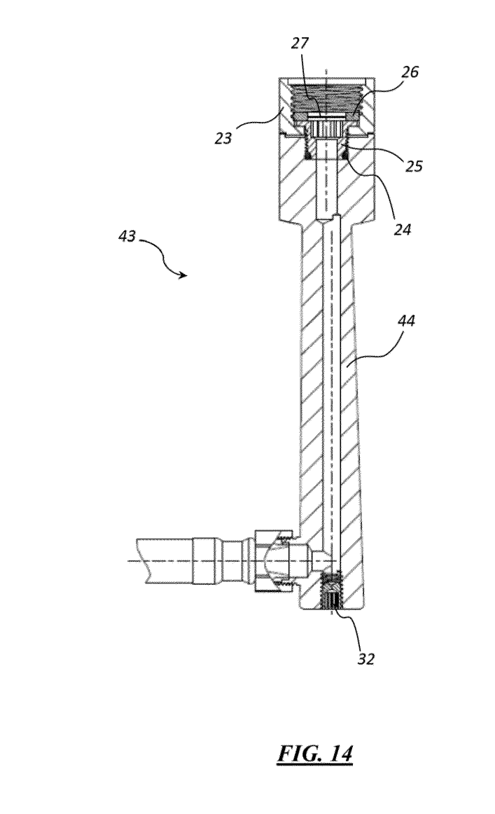

Previous described five water supply fixture examples are primarily designed to work with any electronic bidet toilet seat that has the water inlet facing sideways in the horizontal direction of either right or left side of the electronic bidet toilet seat. Referring to FIG. 13, another water supply fixture 43 (6^{th} example), according to this invention, is designed to work with any electronic toilet seat that has the water inlet facing downward in the vertical direction. This water supply fixture 43 works exactly as the water supply fixture 12, except forging body 44 is used to replace forging body 31. FIG. 14 shows cross-sectional view of water supply fixture 43.

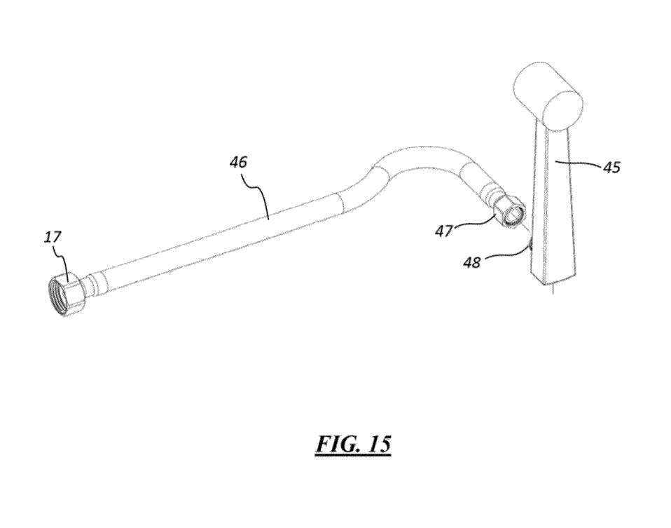

Referring to FIG. 15, an alternate design can be used to hide the unaesthetic flexible supply hose of the electronic bidet toilet seat. In this design, a decorative rigid water supply portion 45 is now an integral part of the electronic bidet toilet seat. A flexible supply hose 46 is used to connect the rigid water supply portion 45 of the electronic bidet toilet seat to a water supply source fitting. Similarly to the six previous examples of this invention, the decorative rigid water supply portion 45 of the electronic bidet toilet seat is used to direct and hide the unaesthetic flexible supply hose 46 underneath the toilet seat.

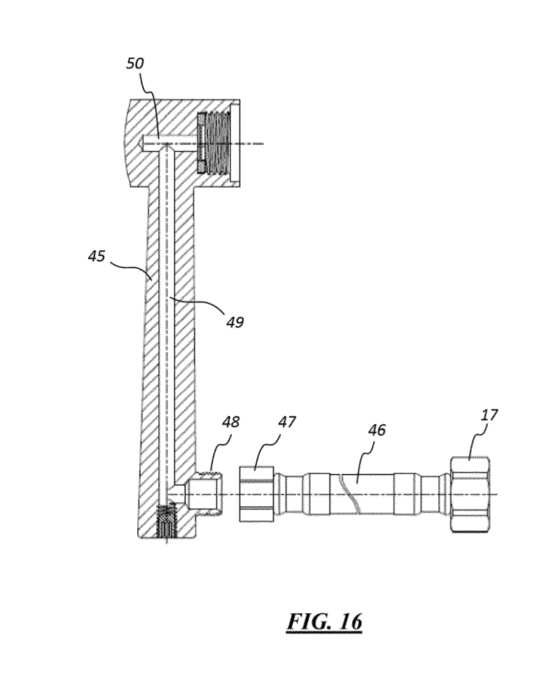

FIG. 16 shows cross-sectional view of the alternate design wherein one end 17 of the flexible supply hose 46 is connected to a water supply source fitting. The other end of the flexible supply hose 46 has a swivel nut 47 which is screwed to thread 48 of the rigid water supply portion 45 of the electronic bidet toilet seat. A gasket or o-ring is used to seal off any water leak between the flexible supply hose 46 and the rigid water supply portion 45. When being used, supply water first pass through the flexible hose 46, then, through the water conduits 49 and 50 of the rigid water supply portion 45 of the electronic bidet toilet seat, and finally to the electronic bidet toilet seat itself.

Although a preferred embodiment of this invention has been disclosed, a worker of ordinary skill in this art would recognize that certain modification would come within the scope of this invention. For that reason, the following claims should be studies to determine the true scope and content of this invention.

What is claimed is:

1. A water supply hose fixture comprising:
a decorative rigid assembly;
a flexible supply hose assembly;
one or multiple fitting adapters to enable the water supply hose fixture to connect with different water supply source fittings.

2. The water supply fixture as recited in claim 1 includes two or more elbows to direct and neatly hide the said flexible supply hose assembly.

3. The water supply fixture as recited in claim 1, when being used, said decorative rigid assembly will occupy the plain sight of the user's view if he or she is in the standing position and looking down to a electronic bidet toilet seat.

4. The water supply fixture as recited in claim 1, when being used, said flexible supply hose assembly is largely and neatly hidden underneath a toilet seat and almost completely out of the user's view if he or she is in the standing position and looking down to a electronic bidet toilet seat.

5. The water supply fixture as recited in claim 1 conduits water from a water supply source to an electronic bidet toilet seat inlet as follows: the water first passes through said optional fitting adapter, then said flexible supply hose assembly and said decorative rigid assembly, and finally to the electronic bidet toilet seat inlet.

6. The said flexible supply hose assembly has a connector end that can be standardized to fit the most common fitting of water supply source.

7. Optional fitting adapters are used to allow the said standardized connector end as recited in claim 6 to fit with other un-common water supply fittings.

8. A decorative rigid assembly of said water supply fixture as recited in claim 1 comprising: a swivel nut that is used to connect said water supply fixture to an electronic bidet toilet seat water inlet;
an elbow body;
an adapter to hold the elbow body and the swivel nut together;
a rubber gasket with optional filter screen; and
a pillar that can rotate around its lengthwise axis.

9. The said rigid assembly as recited in claim 8, not only act as an aesthetic cover, it also conduits water to an electronic bidet toilet seat.

10. The said rigid assembly as recited in claim 8 is not necessarily an integral part of the said flexible hose, to provide the flexibility to design the rigid assembly in various forms or shapes and not have to tie up with the ordinary form of the said flexible supply hose.

11. The said rigid assembly as recited in claim 8 is intentionally designed to not be an integral part of the said flexible hose, so plating color of the said rigid assembly does not have to tie up with a default color of the said flexible supply hose.

12. The said swivel nut and said elbow body of the rigid assembly as recited in claim 8 can be combined together to allow the said elbow body to connect directly to a electronic bidet toilet seat inlet.

13. The said pillar and said elbow body of the rigid assembly as recited in claim 8 can be combined together as one forging, casting, or molding unit.

14. A bended tubular tube threaded or brazed to two adapters can be used to replace the said elbow body and said pillar of the rigid assembly as recited in claim 8.

15. A cover sits on top the said rigid assembly as recited in claim 8 or designed to be an integral part of the said rigid assembly as recited in claim 8, is used to hide an electrical cord of an electronic bidet toilet seat.

16. The water supply fixture as recited in claim 1 can be designed in different configurations so it can work with any electronic bidet toilet seat that has water inlet facing either sideways or vertical downward direction.

17. An electronic bidet toilet seat has a decorative rigid water supply portion that is used to direct and hide the unaesthetic flexible supply hose underneath the toilet seat.
